(19) United States
(12) Patent Application Publication
(10) Pub. No.: US 2004/0047556 A1
(43) Pub. Date: Mar. 11, 2004

(54) Optical module

(76) Inventors: Yoshihide Yasuda, Osaka-shi (JP); Yoshiro Sato, Osaka-shi (JP); Yasufumi Muto, Osaka-shi (JP)

Correspondence Address: POSZ & BETHARDS, PLC, 11250 ROGER BACON DRIVE, SUITE 10, RESTON, VA, 20190, US

(21) Appl. No.: 10/653,058

(22) Filed: Sep. 3, 2003

(30) Foreign Application Priority Data
Sep. 9, 2002 (JP) 2002-263340

(51) Int. Cl. G02B 6/32

(52) U.S. Cl. 385/33

(57) ABSTRACT

An optical module includes an optical fiber array and a lens array. An optical signal is mutually transmitted between the optical fiber array and the lens array. The optical fiber array and the lens array are secured to each other in a state in which the optical fiber array and the lens array are aligned with each other. An optical path is formed between the optical fiber array and the lens array to permit the optical signal through. A hollow spacer is located between opposing surfaces of the optical fiber array and the lens array. A hollow portion is formed in the hollow spacer. The size of the hollow portion is large enough so that the hollow spacer does not interrupt the optical path. The hollow spacer is adhered to the optical fiber array and the lens array to secure the optical fiber array and the lens array.

### BACKGROUND OF THE INVENTION

The present invention relates to an optical module that has two optical parts, such as a fiber array and a lens array, which mutually transmit optical signals.

In the prior art, an optical module as shown in FIGS. 7 and 8 has been proposed. The optical module is formed as a collimator array and includes an optical fiber array 21, which retains optical fibers 20 arranged in a line, and a lens array 23, which includes microlenses 22 arranged in a line. (For example, Japanese Laid-Open Patent Publication 2001-305376) Such an optical module is manufactured by securing opposing surfaces of the optical fiber array 21 and the lens array 23 after aligning the optical fiber array 21 with the lens array 23. The opposing surfaces of the optical fiber array 21 and the lens array 23 are secured by adhesive as shown in FIG. 9 or by holders as shown in FIG. 10.

In the securing method shown in FIG. 9, the opposing surfaces of the optical fiber array 21 and the lens array 23 are directly adhered with adhesive 24 to secure the optical fiber array 21 and the lens array 23. In the securing method shown in FIG. 10, the optical fiber array 21 is secured to an optical fiber holder 25, and the lens array 23 is secured to a lens holder 26. The opposing surfaces of the holders 25, 26 are then secured by adhesive or YAG laser welding.

However, when the optical module is manufactured using the securing method shown in FIG. 9, the adhesive is located in an optical path. Therefore, the adhesive is damaged when high power optical signals are used, which decreases the performance of the optical module. Therefore, the high power output signals cannot be used and the application of the optical module is restricted. When the optical module is manufactured using the securing method shown in FIG. 10, the fiber holder 25 and the lens holder 26 increase the outer dimensions of the entire optical module, and increase the number of parts. This increases the manufacturing cost of the optical module.

### SUMMARY OF THE INVENTION

Accordingly, it is an objective of the present invention to provide an inexpensive optical module that has no resin material in an optical path and is adoptable with high power optical signals.

To achieve the above objective, the present invention provides an optical module, which includes a first optical part, a second optical part, and a hollow spacer. An optical signal is mutually transmitted between the first optical part and the second optical part. The first and second optical parts are secured to each other in a state in which the first and second optical parts are aligned with each other. An optical path is formed between the first and second optical parts to permit the optical signal through. The hollow spacer is located between opposing surfaces of the first and second optical parts. A hollow portion is formed in the hollow spacer. The hollow portion has a size that is large enough so that the hollow spacer does not interrupt the optical path of the optical signal. The first and second optical parts are secured to each other by adhering the hollow spacer to each of the first and second optical parts.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1(a) is a side view illustrating an optical module according to a first embodiment of the present invention;

FIG. 1(b) is a front view illustrating a hollow spacer;

FIG. 2 is a plan view illustrating the optical module shown in FIG. 1(a);

FIG. 3 is a perspective view illustrating the optical module shown in FIG. 1(a);

FIG. 4 is a cross-sectional view illustrating an optical module according to a second embodiment;

FIG. 5 is a cross-sectional view illustrating an optical module according to a third embodiment;

FIG. 6 is a side view illustrating an optical module according to a working example;

FIG. 7 is a plan view illustrating a prior art optical module;

FIG. 8 is a side view illustrating the optical module shown in FIG. 7;

FIG. 9 is a plan view illustrating the optical module shown in FIG. 8 that is secured by adhesive; and

FIG. 10 is a cross-sectional view illustrating the optical module shown in FIG. 8 that is secured by holders.

### DETAILED DESCRIPTION OF THE PREFERRED EMBODIMENTS

An optical module 30 according to a first embodiment of the present invention will now be described with reference to drawings.

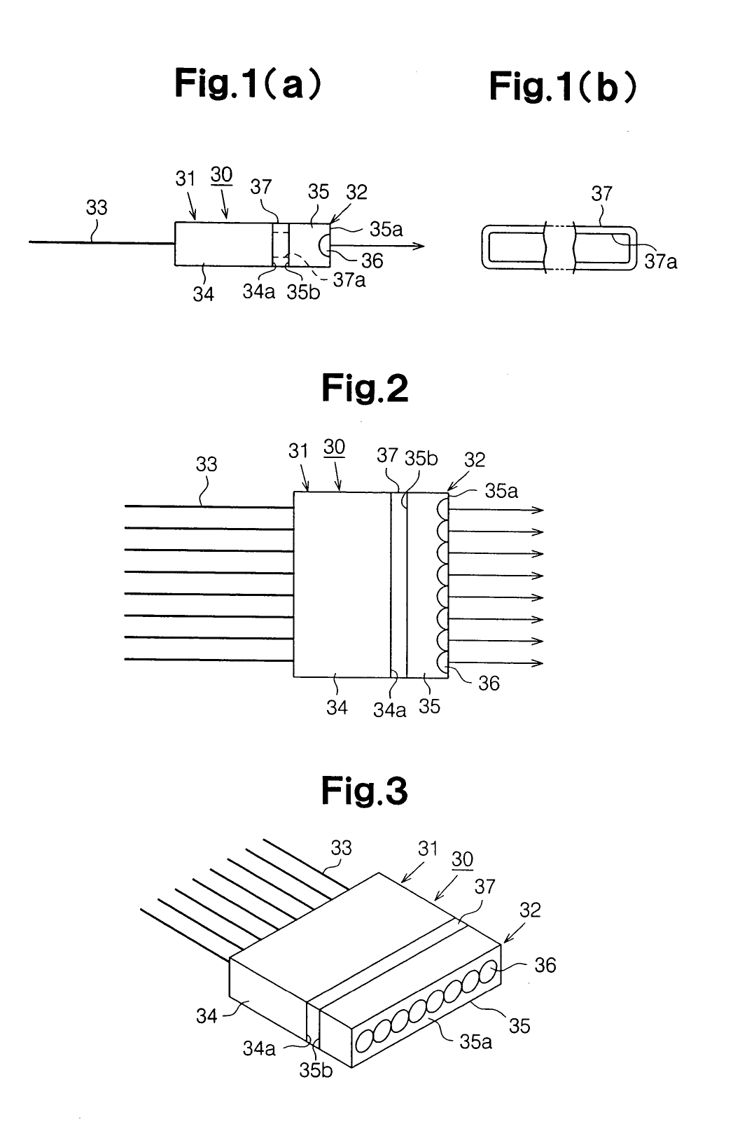

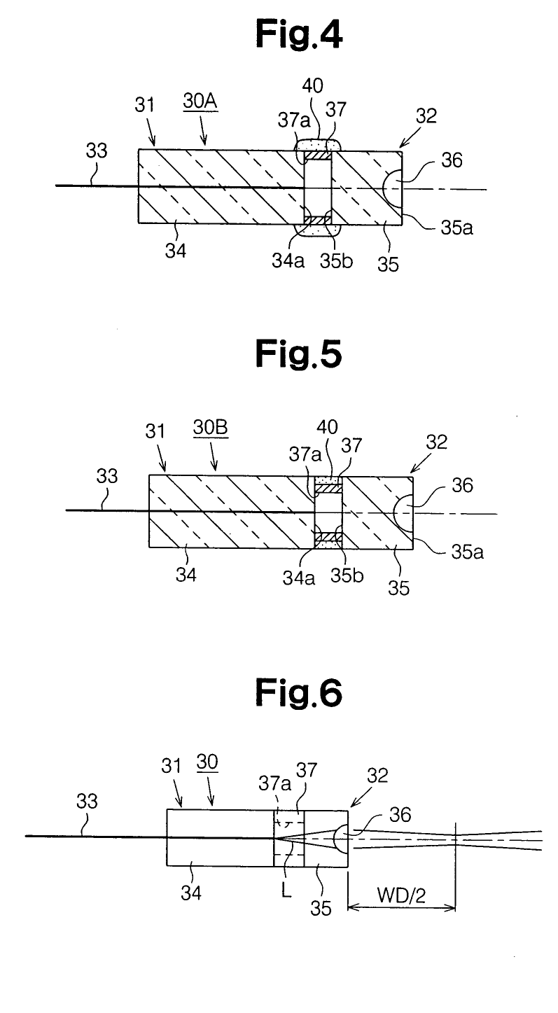

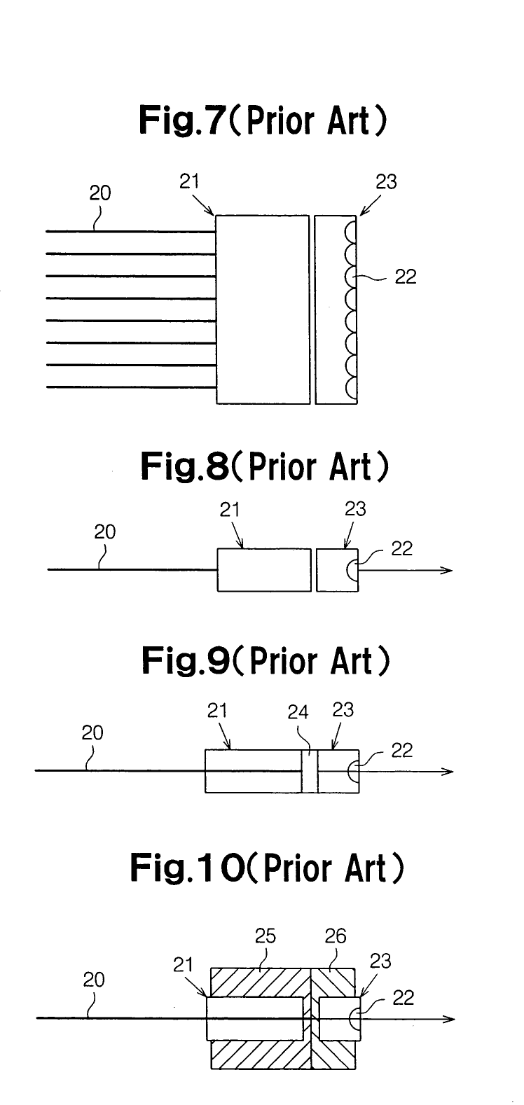

FIGS. 1(a), 1(b), 2, and 3 show an optical module 30 according to a first embodiment. The optical module 30 includes a first optical part, which is an optical fiber array 31 in the first embodiment, and a second optical part, which is a lens array 32 in the first embodiment.

The optical fiber array 31 includes optical fibers (single mode optical fibers) 33 and a capillary 34, which retains the optical fibers 33 arranged in a line. The lens array 32 is constituted by a flat microlens array in which microlenses 36 are arranged in a line on a right end 35a of a transparent lens substrate 35.

The optical module 30 is constituted as a collimator array in which optical signals are mutually transmitted between the optical fiber array 31 and the lens array 32. That is, outgoing light from each of the optical fibers 33 is converted to a parallel beam by the corresponding microlens 36. In contrast, a parallel beam entered from each of the microlens 36 is converged by the microlens 36 and is connected to the corresponding optical fiber 33.

A hollow spacer 37 is arranged between opposing surfaces of the optical fiber array 31 and the lens array 32, that is, between a right end 34a of the capillary 34 and a left end 35b of the lens substrate 35. The hollow spacer 37 has a hollow portion 37a the size of which is large enough so that the hollow spacer 37 does not interrupt a light path L (see FIG. 6) through which the optical signals pass. The optical fiber array 31 and the lens array 32 are secured by adhering the opposing surfaces of the optical fiber array 31 and the lens array 32 with each other via the hollow spacer 37 using adhesive. The hollow spacer 37 has a high machining performance and a low thermal expansion, and is made of inexpensive metal material, such as stainless steel (SUS) and covar. A first adhesive layer (not shown) is formed between the optical fiber array, or the first optical part 31, and the hollow spacer 37. A second adhesive layer (not shown) is formed between the lens array, or the second optical part 32, and the hollow spacer 37.

A method for securing the optical fiber array 31 and the lens array 32 using the hollow spacer 37 will now be described.

The securing method includes the following steps.

In a first step of the securing method, an adhesive, such as an UV cure adhesive or a thermosetting adhesive, is applied to the left side surface of the hollow spacer 37 that faces the capillary 34. The hollow spacer 37 is then adhered to the right end 34a of the capillary 34. At this time, the first adhesive layer is formed.

In a second step, an adhesive, such as an UV cure adhesive or a thermosetting adhesive, is applied to the left end 35b of the lens substrate 35 in advance. After aligning the optical fiber array 31 and the lens array 32 with each other, the left end 35b is adhered to the hollow spacer 37. At this time, the second adhesive layer is formed.

As described above, the optical fiber array 31 and the lens array 32 are adhered to each other via the hollow spacer 37.

The first embodiment formed as above provides the following advantages.

(1) The optical fiber array 31 and the lens array 32 are secured to each other by adhering the opposing surfaces of the optical fiber array 31 and the lens array 32 via the hollow spacer 37, which has the hollow portion 37a the size of which is large enough so that the hollow spacer 37 does not interrupt the optical path. Therefore, a structure in which an adhesive does not exist in the optical path is obtained with a simple structure. Thus, the structure in which an adhesive does not exist in the optical path is achieved at a low cost, and the optical module that is adoptable with high power optical signals is manufactured.

(2) Since the opposing surfaces of the optical fiber array 31 and the lens array 32 are adhered to each other via the hollow spacer 37, it is not necessary to be careful that an adhesive does not enter the optical path during adhering process as in a case where the opposing surfaces of the optical fiber array 31 and the lens array 32 are directly adhered to each other. This facilitates the adhering process, which facilitates the process for securing the optical fiber array 31 and the lens array 32 with each other.

FIG. 4 shows an optical module 30A according to a second embodiment. The optical module 30A has the same structure as the optical module 30 of the first embodiment shown in FIGS. 1(a), 1(b), 2, and 3 except that in the optical module 30A, an adhesive 40, such as epoxy resin, is applied about a securing portion where the opposing surfaces of the optical fiber array 31 and the lens array 32 are secured to each other via the hollow spacer 37. That is, the adhesive 40, such as epoxy resin, is applied about the first and second adhesive layers. The adhesive 40 reinforces the outer perimeter of the optical fiber array 31, the lens array 32, and the hollow spacer 37.

Therefore, in the second embodiment, the securing portion between the optical fiber array 31 and the lens array 32 is reinforced by the adhesive 40, and the moisture resistance of the securing portion is improved by the adhesive 40. Accordingly, an optical module 30A is obtained having a high reliability.

The first adhesive layer between the optical fiber array 31 and the hollow spacer 37 and the second adhesive layer between the lens array 32 and the hollow spacer 37 are joined with the layer of the adhesive 40, or a third adhesive layer, which covers the entire outer perimeter of the hollow spacer 37.

FIG. 5 shows an optical module 30B according to a third embodiment. The structure of the optical module 30B of the third embodiment is substantially the same as the optical module 30A of the second embodiment shown in FIG. 4. In the optical module 30B, the outer dimensions of the hollow spacer 37 are smaller than the outer dimensions of the optical fiber array 31 and the lens array 32. That is, the outer dimensions of the hollow spacer 37 are smaller than the outer dimensions of the right end 34a of the capillary 34 and the outer dimensions of the left end 35b of the lens substrate 35.

In the third embodiment that is formed as mentioned above, an annular recess is formed between the outer surface of the hollow spacer 37, the right end 34a of the capillary 34, and the left end 35b of the lens substrate 35. The adhesive 40 is filled in the recess to reinforce the securing portion between the optical fiber array 31 and the lens array 32 with the adhesive 40. Since the annular recess is formed, the adhesive 40 is prevented from protruding from the outer perimeter of the optical fiber array 31 and the lens array 32. Accordingly, the outer dimensions of the entire optical module 30B are substantially uniform.

A working example of the optical module corresponding to the first embodiment shown in FIGS. 1 to 3 is described with reference to FIG. 6.

The solid state properties of the optical module 30 according to the working example are as described bellow. The lens array 32 of the optical module 30 uses a flat microlens array in which the microlenses 36 are arranged in a line at 0.25 mm pitch.

The outer diameter φ of each microlens 36 is 0.25 mm. The focal distance f of each microlens 36 is 0.750 mm (Wave length: 1550 nm). The refractive index n of the lens substrate 35 is 1.523. The thickness t1 of the lens substrate 35 is 0.8 mm. The refractive index n of the core of each optical fiber 33 is 1.467. The optical fibers 33 are single mode optical fibers. The thickness t2 of the hollow spacer 37 is 0.3 mm.

The optical module 30 (collimator array) having the working distance WD of 10 mm and the insertion loss that is less than or equal to 1.0 dB is manufactured by the members having the above mentioned solid state properties. The working distance refers to the maximum collimator length. The distance between the right end 35a of the lens substrate 35 and the beam waist of the parallel beam corresponds to half the working distance WD.

It should be apparent to those skilled in the art that the present invention may be embodied in many other specific forms without departing from the spirit or scope of the invention. Particularly, it should be understood that the invention may be embodied in the following forms.

In the above embodiments, the optical module 30 having the optical fiber array 31 and the lens array 32 are described. However, the present invention is not limited to have such structure. The present invention may be widely applied to optical modules having first and second optical parts, which mutually transmit optical signals and are secured to each other by adhering the opposing surfaces after alignment. In this case, the same advantages as the first embodiment are provided by arranging, between the first and second optical parts, a hollow spacer having a hollow the size of which is large enough so that the hollow spacer does not interrupt an optical path through which optical signals pass, and securing the opposing surfaces of the first and second optical parts via the hollow spacer.

The hollow spacer 37 used in the above embodiments may have any shape as long as the hollow spacer 37 has the hollow portion 37a the size of which is large enough so that the hollow spacer 37 does not interrupt the optical path L (see FIG. 6) through which optical signals pass.

When the hollow spacer 37 is thin, the hollow spacer 37 is not easily affected by thermal expansion. The hollow spacer may be formed by resin material instead of the metal material.

In the above embodiments, the thickness of the hollow spacer 37 is preferably set taking into consideration of the thicknesses of the adhesive layers formed between the hollow spacer 37 and the right end 34a of the capillary 34 and between the hollow spacer 37 and the left end 35b of the lens substrate 35. For example, the hollow spacer 37 is formed to have the thickness obtained by subtracting the thicknesses of the adhesive layers formed on both sides of the hollow spacer 37 from the predetermined distance between the optical fiber array 31 and the lens array 32.

In the first embodiment, the lens array 32 is constituted by the flat microlens array in which the microlenses 36 are formed on the transparent lens substrate 35 by an ion-exchange method. However, the present invention is not limited to have such structure, but several types of microlenses may be used. For example, after forming a lenticular resin layer on a glass, a lens array may be manufactured by reactive ion etching (RIE) method using anisotropic etching, or a resin lens array may be manufactured by molding. The lens array 32 may be formed by arranging microlenses, which are gradient index rod lenses.

In the above embodiments, the optical modules 30, 30A, and 30B are constituted by the optical fiber array 31, which has the optical fibers 33, and the lens array 32, which has the microlenses 36. However, the present invention is not limited to have such structure. That is, the present invention may be applied to a collimator that includes a single core capillary, which has an optical fiber, and a flat microlens, which has a microlens, or a rod lens.

The present examples and embodiments are to be considered as illustrative and not restrictive and the invention is not to be limited to the details given herein, but may be modified within the scope and equivalence of the appended claims.

1. An optical module comprising:
a first optical part;
a second optical part, wherein an optical signal is mutually transmitted between the first optical part and the second optical part, wherein the first and second optical parts are secured to each other in a state in which the first and second optical parts are aligned with each other, and wherein an optical path is formed between the first and second optical parts to permit the optical signal through; and
a hollow spacer located between opposing surfaces of the first and second optical parts, wherein a hollow portion is formed in the hollow spacer, wherein the hollow portion has a size that is large enough so that the hollow spacer does not interrupt the optical path of the optical signal, and wherein the first and second optical parts are secured to each other by adhering the hollow spacer to each of the first and second optical parts.

2. The optical module according to claim 1, wherein the first optical part is an optical fiber array, which has at least one optical fiber, and wherein the second optical part is a lens array, which has at least one microlens.

3. The optical module according to claim 1, wherein a first adhesive layer is formed between the first optical part and the hollow spacer, and wherein a second adhesive layer is formed between the second optical part and the hollow spacer.

4. The optical module according to claim 3, wherein the first and second adhesive layers are joined to a third adhesive layer, which covers the entire outer perimeter of the hollow spacer.

5. The optical module according to claim 4, wherein the outer dimensions of the hollow spacer are smaller than the outer dimensions of the first and second optical parts, thereby forming a recess between the first and second optical parts and the hollow spacer, and wherein an adhesive is filled in the recess to form the third adhesive layer.

6. An optical module comprising:
an optical fiber array, which includes a plurality of optical fibers extending parallel to each other;
a lens array, which includes a plurality of microlenses arranged in a line, wherein each microlens corresponds to one of the optical fibers; and
a hollow spacer located between the optical fiber array and the lens array, wherein the hollow spacer is secured to the optical fiber array and the lens array with an adhesive, and wherein a hollow portion is formed in the hollow spacer to permit an optical signal to be mutually transmitted between each optical fiber and the corresponding microlens.

7. The optical module according to claim 6, wherein a first adhesive layer is formed between the optical fiber array and the hollow spacer, and wherein a second adhesive layer is formed between the lens array and the hollow spacer.

8. The optical module according to claim 7, wherein the first and second adhesive layers are joined to a third adhesive layer, which covers the entire outer perimeter of the hollow spacer.

9. The optical module according to claim 8, wherein the outer dimensions of the hollow spacer are smaller than the outer dimensions of the optical fiber array and the lens array thereby forming a recess between the optical fiber array, the lens array, and the hollow spacer, and wherein an adhesive is filled in the recess to form the third adhesive layer.
